(19) United States
(12) Patent Application Publication
(10) Pub. No.: US 2018/0333735 A1
(43) Pub. Date: Nov. 22, 2018

(54) Ultrasonic Atomizer Device

(71) Applicant: Zhihui Song, Shenzhen (CN)

(72) Inventor: Zhihui Song, Shenzhen (CN)

(21) Appl. No.: 15/687,424

(22) Filed: Aug. 25, 2017

(30) Foreign Application Priority Data
May 17, 2017 (CN) 201710345486.6

(51) Int. Cl. B05B 17/06; B05B 7/00; A63J 5/02

(52) U.S. Cl. CPC B05B 17/06; A63J 5/025; B05B 7/0081

(57) ABSTRACT

An ultrasonic atomizer device includes a bottom shell, a fan, a water tank, a water tank cover, an ultrasonic atomizing plate, an outer cover, and a cavity formed among the outer cover, the water tank and the water tank cover. Air flow generated by the fan enters the cavity through two paths. In one of the paths, the air flow enters the water tank through the inner air outlet inside the water tank, and water mist generated by the ultrasonic atomizing plate arranged at the bottom of the water tank is blown into the cavity from the inside of the water tank via the mist discharge grooves on the periphery of the water tank cover; and in the other path, the air flow directly enters the cavity from the air outlet holes at the periphery of the lower side of the water tank.

### CROSS-REFERENCE TO RELATED APPLICATION

This application claims priority to Chinese Application No. 201710345486.6 filed on May 17, 2017, the entire contents of which are hereby incorporated by reference.

### TECHNICAL FIELD

The present disclosure relates to the field of atomizer devices, in particular to a novel ultrasonic atomizer device with the special effect of fogs and clouds.

### BACKGROUND

At present, the yield and sales of ultrasonic atomizing devices are rapidly increasing, a small-size ultrasonic atomizing devices product is also called an aroma diffuser, wherein a few drops of essential oil are added in the water of a water tank, the ultrasonic atomizing plate atomizes the water and the essential oil into water mist, and the air from an air outlet blows the water mist out from a mist outlet, so as to diffuse the aroma.

In recent years, aroma diffusers with special visual effects are more likely to succeed in marketing, such as those with colorful LED lamps, with a Bluetooth audio function, or with a glass or ceramic outer cover. For example, the patent No. 201220145329.3 discloses an aroma atomizer with a translucent film provided on the surface so that a user can draw on the film and also can change the film or the drawing to present more colorful art pictures, making the device more beautiful.

Accordingly, an atomizer with a special visual effect is needed on the market to meet favors and demands of users.

### SUMMARY

For solving the above problem, the present disclosure provides a novel ultrasonic atomizer device, wherein an outer cover is used so that the water mist forms the special visual effect of fogs and clouds in a cavity formed among a water tank, a water tank cover and the outer cover, and even after the novel ultrasonic atomizer device is used for a long time, water vapor will not condense on the surface of the outer cover, so that the effect can be sustained to bring better visual effects to users.

In order to realize the above objective, the present disclosure provides a technical solution as follows: a novel ultrasonic atomizer device comprises a bottom shell, a fan, a water tank, a water tank cover and an ultrasonic atomizing plate, wherein the fan is fixedly arranged at the lower end inside the bottom shell, the water tank is arranged above the fan, the water tank cover covers the upper end of the water tank, and the ultrasonic atomizing plate is fixedly arranged at the bottom of the water tank in communication with the water tank. The novel ultrasonic atomizer device also comprises an outer cover, the outer cover covers the upper end of the bottom shell, a cavity is formed among the outer cover, the water tank and the water tank cover, an inner air outlet is provided inside the water tank, a part of air flow generated by the fan enters the water tank through the inner air outlet, the water tank cover is provided with a plurality of mist discharge grooves, the inside of the water tank communicates with the cavity through the mist discharge grooves, the air flow inside the water tank enters the cavity through the mist discharge grooves and at the same time the water mist generated by the ultrasonic atomizing plate follows the air flow to enter the cavity through the mist discharge grooves, air outlet holes are also provided on the outer edge of the lower side of the water tank, the other part of the air flow generated by the fan enters the cavity through the air outlet holes, a water collecting trough for collecting mist droplets condensed on the surface of the water tank outer wall is also provided on the lower periphery of the air outlet holes on the water tank outer wall, a mist guidance pipe is provided at the upper end inside the outer cover, the cavity communicates with the outside through the mist guidance pipe, and the air flow in the cavity flows out through the mist guidance pipe.

Specifically, the water tank cover is alternately provided with gear concave surfaces and gear convex surfaces on the periphery, the gear convex surface is provided with a support rib at the upper part, which is clamped to the upper end of the water tank when the water tank cover covers the water tank, and the mist discharge groove is formed between the gear concave surface and the water tank.

Specifically, the outer cover is a transparent plastic outer cover or a transparent glass outer cover.

Specifically, the mist discharge grooves are arranged on the upper end or side surface of the water tank cover.

The present disclosure has beneficial effects in that: in the novel ultrasonic atomizer device provided by the present disclosure, the air flow generated by the fan enters the cavity through two paths, wherein in one of the paths, the air flow enters the water tank through the inner air outlet inside the water tank, and the water mist generated by the ultrasonic atomizing plate arranged at the bottom of the water tank is blown into the cavity from the inside of the water tank via the mist discharge grooves on the periphery of the water tank cover; and in the other path, the air flow directly enters the cavity from the air outlet holes at the periphery of the lower side of the water tank. Since the air on the edges of the air outlet holes has a high velocity and a low pressure, the water mist entering the cavity from the mist discharge grooves on the periphery of the water tank cover above is sucked to the air outlet holes below to combine with the air flow blown into the cavity from the air outlet holes, the combined water mist and air flow move upward to form the effect of fogs and clouds in the cavity, and finally flow out from the mist guidance pipe on the outer cover, thereby bringing better visual effects to users.

In addition, the mist guidance pipe in the middle of the upper end of the outer cover is the only outlet for the water mist and air flow inside the cavity, and therefore the water mist and the air flow moving upward are gathered towards the mist guidance pipe in the middle of the outer cover to keep a short distance away from the inner wall of the outer cover so that water mist won't condense on the inner wall of the outer cover, thereby sustaining the visual effect of fogs and clouds; and some of the water mist condenses into water droplets on the water tank outer wall due to prolonged operation, the water droplets flow downward and then the water collecting trough collects the condensed droplets to prevent them from flowing out to the table.

### BRIEF DESCRIPTION OF THE DRAWINGS

FIG. 1 is a cross-sectional view of a structure of the present disclosure.

FIG. 2 is a structural diagram of a water tank of the present disclosure.

FIG. 3 is a structural diagram of a water tank cover of the present disclosure.

Reference numerals: 1. Bottom shell; 2. Fan; 3. Water tank; 31. Inner air outlet; 32. Air outlet hole; 33. Water collecting trough; 34. Water tank outer wall; 4. Water tank cover; 41. Mist discharge groove; 42. Gear concave surface; 43. Gear convex surface; 44. Support rib; 45 ultrasonic atomizing plate; 6. Outer cover; 61. Mist guidance pipe; 7. Cavity.

### DETAILED DESCRIPTION

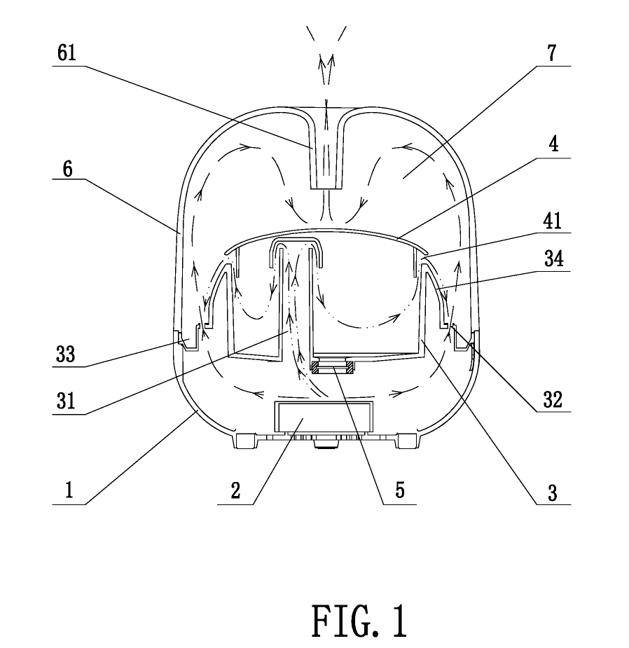

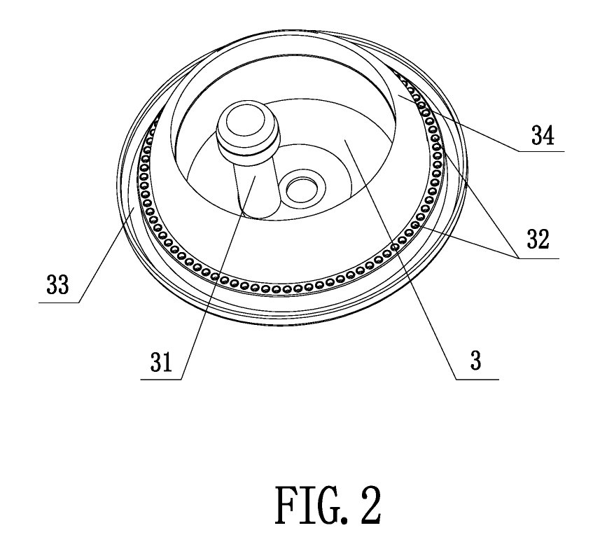

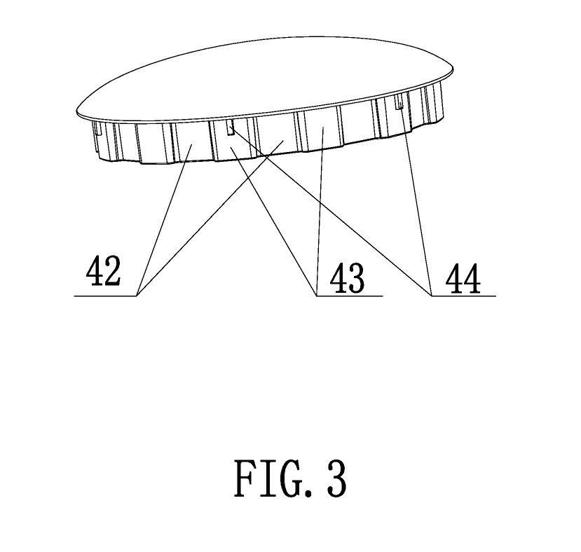

With reference to FIGS. 1 to 3, the present disclosure provides a novel ultrasonic atomizer device, comprising a bottom shell 1, a fan 2, a water tank 3, a water tank cover 4 and an ultrasonic atomizing plate 5, wherein the fan 2 is fixedly arranged at the lower end inside the bottom shell 1, the water tank 3 is arranged above the fan 2, the water tank cover 4 covers the upper end of the water tank 3, and the ultrasonic atomizing plate 5 is fixedly arranged at the bottom of the water tank 3 in communication with the water tank 3 and is used for transforming water in the water tank 3 into water mist. The novel ultrasonic atomizer device also comprises an outer cover 6, the outer cover 6 covers the upper end of the bottom shell 1, a cavity 7 is formed among the outer cover 6, the water tank 3 and the water tank cover 4, an inner air outlet 31 is provided inside the water tank 3, a part of air flow generated by the fan 2 enters the water tank 3 through the inner air outlet 31, a plurality of mist discharge grooves 41 are provided on the periphery of the water tank cover 4, the inside of the water tank 3 communicates with the cavity 7 through the mist discharge grooves 41, the air flow inside the water tank 3 enters the cavity 7 through the mist discharge grooves 41 and at the same time the water mist generated by the ultrasonic atomizing plate 5 follows the air flow to enter the cavity 7 through the mist discharge grooves 41, air outlet holes 32 are also provided on the outer side of the lower part of the water tank 3, the other part of the air flow generated by the fan 2 enters the cavity 7 through the air outlet holes 32, a water collecting trough 33 for collecting mist droplets condensed on the surface of the water tank outer wall 34 is also provided on the lower periphery of the air outlet holes 32 on the water tank outer wall 34, a mist guidance pipe 61 is provided at the upper end inside the outer cover 6, the cavity 7 communicates with the outside through the mist guidance pipe 61, and air flow in the cavity 7 flows out through the mist guidance pipe 61.

As compared with the prior art, in the ultrasonic atomizer device provided by the present disclosure, the air flow generated by the fan 2 is divided into two paths to enter the cavity 7 by the inner air outlet 31 inside the water tank 3 and the air outlet holes 32 at the periphery of the lower side of the water tank 3, wherein in one of the paths, air flow enters the water tank 3 through the inner air outlet 31 inside the water tank 3, and then the water mist generated by the ultrasonic atomizing plate 5 is blown into the cavity 7 through the mist discharge grooves 41 on the periphery of the water tank cover 4, and in the other path, the air flow directly enters the cavity 7 from the air outlet holes 32 at the periphery of the lower side of the water tank 3. Since the air at the edges of these air outlet holes 32 has a high velocity and a low pressure, the water mist entering the cavity 7 from the mist discharge grooves 41 on the periphery of the water tank cover 4 above is sucked downward to the air outlet holes 32 to combine with the air flow blown into the cavity 7 from the air outlet holes 32, the combined water mist and air flow move upward to form the effect of fogs and clouds in the cavity 7 and finally flow out from the mist guidance pipe 61 on the outer cover 6.

Specifically, the water tank cover 4 is alternately provided with gear concave surfaces 42 and gear convex surfaces 43 on the periphery, the gear convex surface 43 is provided with a support rib 44 at the upper part, which is clamped to the upper end of the water tank 3 when the water tank cover 4 covers the water tank 3, and the mist discharge grooves 41 are formed between the gear concave surfaces 42 and the water tank 43.

Formation of the mist discharge grooves 41 by gears is implemented in the above solution, wherein the water tank cover 4 is spaced from the water tank 3 when the water tank cover 4 cover the upper end of the water tank 3 due to the support ribs 44, and the gear concave surfaces 42 and the gear convex surfaces 43 are arranged alternately on the periphery of the water tank cover 4 so that the mist discharge grooves 41 are formed between the water tank cover 4 and the water tank 3.

Besides, the mist discharge grooves 41 may also be directly provided on the upper end or side surface of the water tank cover 4.

Specifically, the outer cover 6 is a transparent plastic outer cover 6 or a transparent glass outer cover 6.

In this embodiment, the effect of fogs and clouds can be seen through the transparent outer cover 6, making the device pleasing to the eye and the mind.

In this embodiment, the basic principle for achieving the effect of fogs and clouds is as follows:

a. the ultrasonic atomizing plate 5 transforms the water inside the water tank 3 into water mist, a part of the air flow generated by the fan 2 on the bottom shell 1 enters the water tank 3 via the inner air outlet 31 inside the water tank 3, and enters the cavity 7 together with the water mist inside the water tank 3 through the mist discharge grooves 41 on the periphery of the water tank cover 4;

b. the other part of the air flow generated by the fan 2 directly enters the cavity 7 from the air outlet holes 32 at the periphery of the water tank 3; and

c. according to principles of hydrodynamics, the air at the edges of air outlet holes 32 has a high velocity and a low pressure, so the water mist and the air flow entering the cavity 7 from the mist discharge grooves 41 are sucked to the air outlet holes 32 below and then forms a combination of water mist and air flow with the air flow from the air outlet holes 32, and the combined water mist and air flow move upward to achieve the effect of fogs and clouds and finally flow out from the mist guidance pipe 61 on the outer cover 6;

d. after operation for a long time, some of the water mist condenses into water droplets on the water tank outer wall 34, and the water droplets flow downward to be collected into the water collecting trough 33.

In the embodiment, the mist guidance pipe 61 in the middle of the upper end of the outer cover 6 is the only outlet for the water mist and air flow inside the cavity 7, and therefore the water mist and the air flow moving upward are gathered towards the mist guidance pipe 61 in the middle of the outer cover 6 to keep a short distance away from the inner wall of the outer cover 6 so that the water mist won't condense on the inner wall of the outer cover 6, thereby sustaining the visual effect of fogs and clouds. Some of the water mist condenses into water droplets on the water tank outer wall 34 due to prolonged operation, the water droplets flow downward and at this moment the water collecting trough 33 collects the condensed droplets to prevent them from flowing out to the table; meanwhile, users need to regularly empty the condensed water out of the water collecting trough 33 or else the condensed water will overflow to the table though it won't enter the fan 2.

The above embodiments are merely described as preferred embodiments of the present disclosure, but not intended to limit the scope of the present disclosure, and any variations and modifications of the technical solutions of the present disclosure made by people of ordinary skill in the art without departing from the design spirit of the present disclosure shall fall in the protection scope defined by claims of the present disclosure.

1. An ultrasonic atomizer device, comprising a bottom shell, a fan, a water tank, a water tank cover, and an ultrasonic atomizing plate, the fan being fixedly arranged at the lower end inside the bottom shell, the water tank being arranged above the fan, the water tank cover covering the upper end of the water tank, and the ultrasonic atomizing plate being fixedly arranged at the bottom of the water tank in communication with the water tank, wherein the ultrasonic atomizer device also comprises an outer cover, the outer cover covers the upper end of the bottom shell, a cavity is formed among the outer cover, the water tank and the water tank cover, an inner air outlet is provided inside the water tank, a part of air flow generated by the fan enters the water tank through the inner air outlet, the water tank cover is provided with a plurality of mist discharge grooves, the inside of the water tank communicates with the cavity through the mist discharge grooves, the air flow inside the water tank enters the cavity through the mist discharge grooves, air outlet holes are also provided on the outer edge of the lower side of the water tank, the other part of air flow generated by the fan enters the cavity through the air outlet holes, a water collecting trough is also provided on the lower periphery of the air outlet holes on the water tank outer wall, a mist guidance pipe is provided at the upper end inside the outer cover, the cavity communicates with the outside through the mist guidance pipe, and the air flow in the cavity flows out through the mist guidance pipe.

2. The ultrasonic atomizer device according to claim 1, wherein the water tank cover is alternately provided with gear concave surfaces and gear convex surfaces on the periphery, the gear convex surface is provided with a support rib at the upper part, which is clamped to the upper end of the water tank when the water tank cover covers the water tank, and the mist discharge groove is formed between the gear concave surface and the water tank.

3. The ultrasonic atomizer device according to claim 1, wherein the outer cover is a transparent plastic outer cover or a transparent glass outer cover.

4. The ultrasonic atomizer device according to claim 1, wherein the mist discharge grooves are arranged on the upper end or side surface of the water tank cover.
